(19) United States
(12) Patent Application Publication
(10) Pub. No.: US 2006/0176398 A1
(43) Pub. Date: Aug. 10, 2006

(54) Broadcast receiving apparatus having screen switching time display function and method thereof

(75) Inventor: Eun-young Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/348,233

(22) Filed: Feb. 7, 2006

(30) Foreign Application Priority Data
Feb. 7, 2005 (KR) 2005-11093

(51) Int. Cl. H04N 5/445; H04N 5/45

(52) U.S. Cl. 348/564; 348/565

(57) ABSTRACT

A broadcast receiving apparatus having a screen switching time display function and a method thereof. The broadcast receiving apparatus includes a control signal receiver for receiving screen switch commands for switching to a certain screen, a display for displaying the time required to switch screens according to a screen switch command, and a controller for controlling the display so as to count the time required to switch screens according to a screen switch command and display the time on a display, when the screen switch command is received. Accordingly, a user can confirm the screen switching time.

### CROSS-REFERENCE TO RELATED APPLICATIONS

This application claims benefit under 35 U.S.C. § 119 from Korean Patent Application No. 2005-11093 filed on Feb. 7, 2005 in the Korean Intellectual Property Office, the entire content of which is incorporated herein by reference.

### BACKGROUND OF THE INVENTION

1. Field of the Invention

The present invention relates to a broadcast receiving apparatus having a screen switching time display function and a method thereof. More specifically, the invention relates to a broadcast receiving apparatus having a screen switching time display function and a method thereof, in which, when a user switches channels or switches to a screen displaying additional services that the user is to use, the time required to switch screens is displayed on the screen.

2. Description of the Related Art

FIG. 1 shows a screen switching display function of a conventional broadcast receiving apparatus.

Referring to FIG. 1, conventionally, messages 20 such as “Screen switching is in progress . . . ” or “Loading . . . ” are displayed on a screen 10 while screens are being switched. That is, when a user handles a remote controller to switch channels or to select an additional service that the user desires while watching a broadcast program corresponding to a certain channel, those messages 20 are displayed on the screen 10 until the screen is switched to another screen displaying the selected channel or listing additional services.

Specifically, due to advancements in digital broadcasting, broadcasting stations provide various kinds of additional information to users, and broadcast receiving apparatuses output a lot of information on screens. The additional information includes Multimedia and Hypermedia information coding Expert Group (MHEG) data, Multimedia Home Platform (MHP) data, Electronic Program Guide (EPG) data, and the like, and these additional services provide various kinds of information to users in addition to video and audio services. In this way, as additional services grow in volume, switching to a screen listing additional services takes more time.

Therefore, if it takes too much time for switching screens, a user may misunderstand that the broadcast receiving apparatus has performed a malfunction. Otherwise, in a case where the screen switching takes a longer time, the user may additionally handle a remote controller or keys, so that the screen switches to a screen that lists unwanted additional services.

### SUMMARY OF THE INVENTION

The present invention has been made in order to address the above drawbacks and other problems in the art. An aspect of the invention is to provide a broadcast receiving apparatus having a screen switching time display function and a method thereof, in which the time required to switch screens is counted, and the screen switching time is displayed until a channel is switched to another channel that a user desires or a screen is switched to another screen listing desired additional services, thereby mitigating users' inconvenience caused by the delay of screen switching.

According to one aspect of the invention, there is provided a broadcast receiving apparatus comprising a control signal receiver for receiving screen switch commands for switching to a certain screen, a display for displaying the time required to switch screens according to the screen switch commands, and a controller for controlling the display so as to count the time required to switch screens according to the screen switch commands and display the time on the display, when the screen switch commands are received.

In addition, the broadcast receiving apparatus according to the invention further comprises a buffer for storing at least one switching time, in which the controller controls the display so as to further display at least any one of the longest switching time, latest switching time taken to switch screens most recently, and average switching time of one or more switching times stored in the buffer, from amongst the switching times stored in the buffer.

The controller may control the display so as to display the switching time required to switch screens according to the screen switch command in the form of a progress bar.

On the other hand, a method of displaying a screen switching time of a broadcast receiving apparatus according to an embodiment of the invention comprises receiving a screen switch command for switching to a certain screen, counting the switching time required to switch screens according to the screen switch command, and displaying the switching time on the screen.

Also, in the operation of displaying the switching time, from amongst the switching times, at least any one of the longest switching time, latest switching time taken to switch screens most recently, and average switching time of one or more stored switching times may be further displayed.

### BRIEF DESCRIPTION OF THE DRAWINGS

The above aspects and features of the present invention will be more apparent by describing certain embodiments of the present invention with reference to the accompanying drawings, in which:

FIG. 1 shows a screen switching display function of a conventional broadcast receiving apparatus;

FIG. 2 is a block diagram showing a configuration of a broadcast receiving apparatus according to one embodiment of the invention;

FIG. 3A shows an example of a screen switching time display function of the broadcast receiving apparatus according to one embodiment of the invention;

FIG. 3B shows an example of a screen switching time display function of the broadcast receiving apparatus according to another embodiment of the invention; and

FIG. 4 is a flowchart explaining the operation of the broadcast receiving apparatus according to one embodiment of the invention.

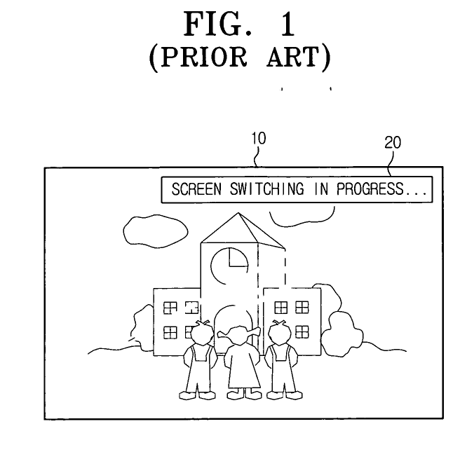

### DETAILED DESCRIPTION OF THE PREFERRED EMBODIMENTS

Certain embodiments of the present invention will be described in greater detail with reference to the accompanying drawings.

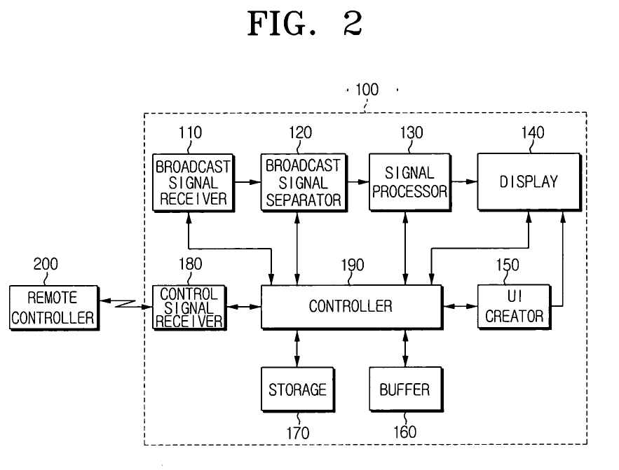

FIG. 2 is a block diagram showing a configuration of a broadcast receiving apparatus according to one embodiment of the invention.

Referring to FIG. 2, the broadcast receiving apparatus 100 comprises a broadcast signal receiver 110, a broadcast signal separator 120, a signal processor 130, a display 140, a UI creator 150, a buffer 160, a storage 170, a control signal receiver 180, and a controller 190.

The broadcast signal receiver 110 receives broadcast signals transmitted from a certain broadcasting station according to the control of the controller 190 that is described below. Here, the broadcast signals are transmitted from the broadcasting station to the broadcast receiving apparatus 100 through a route such as ground waves, wires, and satellites.

The broadcast signal separator 120 demodulates received broadcast signals into base-band signals, and separates the signals into video signals, audio signals, and additional service signals. The video signals are signals for displaying images, and the audio signals are signals for outputting sounds. The additional service signals are signals including MHEG data, MHP data, EPG data, and the like for providing various kinds of information to users.

The MHEG is a specification standardized by ISO/IEC JTC 1/SC 29/WG 12 in order to represent multimedia and hypermedia information objects in the form of codes using diverse media so that applications and services are compatible with each other. The MHP is a specification similar to the Directory Access Service Element (DASE) of the Advanced Television System Committee (ATSC). Regardless of the transmission route such as cables, ground waves, and satellites, applications are provided in the form of diverse terminals such as a DVB (Digital Video Broadcasting) compatible network, low-end and high-end set-top boxes, integrated digital TV (iDTV), and multimedia PCs. The EPG is an electronic program guide including the title of a broadcast program, channel number, broadcasting time, and broadcast contents. Referring to the EPG, a user can select and watch the most preferred program from among several programs, and can confirm in advance information on the programs to be broadcasted in the coming hours.

The signal processor 130 performs signal processes on video signals and audio signals in order to output images and sounds. At this point, a user handles a remote controller 200 or a keypad (not shown) in order to set a video mode or audio mode, and the controller 190 controls the signal processor 130 in order to perform signal processes on video signals and audio signals according to the set mode.

The display 140 outputs the video signals and audio signals processed at the signal processor 130 as images and sounds. At this point, the images outputted from the display 140 include the signal-processed video signals and the UI windows created by the UI creator 150 described below. Also, when screens are switched, the display 140 displays the time required to switch screens, together with the images.

The UI creator 150 creates UI windows for providing users with On Screen Display's (OSD) and additional services needed to perform the operations of the broadcast receiving apparatus 100. That is, an OSD menu is created in order to determine whether switching times are displayed automatically or displayed manually according to a user's handling of the remote controller 200, when switching screens. In addition, a UI window listing the MHEG data, MHP data, and EPG data separated at the broadcast signal separator 120 is created. Through UI windows, a user can confirm additional services provided by broadcasting stations, and can input commands for requesting certain services from the broadcasting stations.

At least one switching time required to switch screens is stored in the buffer 160. That is, the controller 190 counts the switching time required to switch screens and stores it in the buffer 160 sequentially. Such a switching time includes the latest switching time taken to switch screens most recently.

Various control data required to perform the operations of the broadcast receiving apparatus 100 are stored in the storage 170. In addition, various additional signals such as the MHEG data, MHP data, and EPG data separated from broadcast signals are stored in the storage 170.

The control signal receiver 180 receives external control signals from a user entered through a remote controller 200 or a key handler (not shown), and transfers them to the controller 190 described below. That is, in a case where a user is to switch a screen currently displayed to a screen of another channel or to a screen displaying additional services that the user is to use, the user handles certain keys on a remote controller 200 or a key handler, thereby inputting a screen switch command.

The controller 190 controls the broadcast signal receiver 110 described above so as to receive the broadcast signals corresponding to the channel selected by a user. In addition, the controller 190 controls the broadcast signal separator 120 so as to separate the broadcast signals into video signals, audio signals, and additional signals, and controls the signal processor 130 described above in detail so as to perform signal processes on the separated video signals and audio signals in the video mode or audio mode selected by the user. Also, the controller 190 controls the display 140 so that the signal-processed signals are outputted as images and sounds respectively.

Upon receiving a screen switch command through the control signal receiver 180, the controller 190 counts the time required to switch channels or for switching to a screen displaying additional services according to the received screen switch command. Then, the controller 190 controls the display 140 described above in detail so as to display the switching time on the screen when switching screens.

Here, a user can select through an OSD menu whether a switching time is displayed automatically or manually on a screen. In the case where a user selects the automatic display, a switching time is automatically displayed on a screen when screens are switched, and in the case where a user selects the manual display, if the user presses a certain key, a switching time is displayed on a screen when screens are switched.

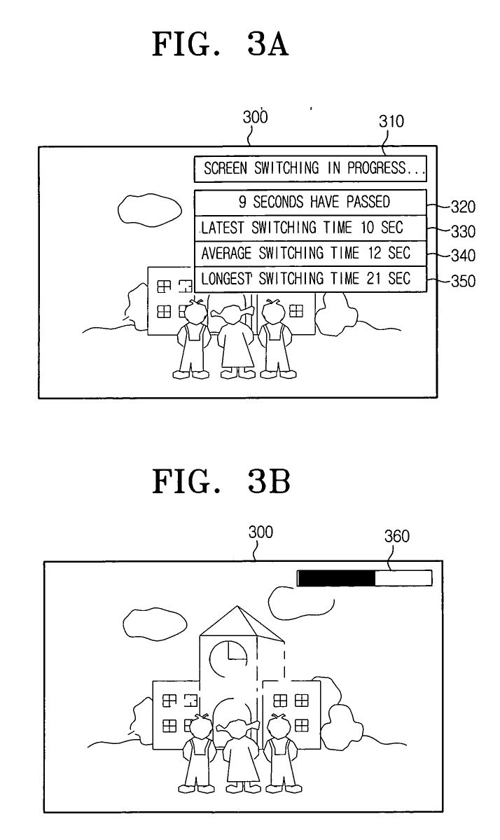

FIG. 3A shows an example of a screen switching time display function of the broadcast receiving apparatus according to one embodiment of the invention.

Referring to FIG. 3A, a switching time 320, latest switching time 330, average switching time 340, and longest switching time 350 are displayed on the screen 300 of the broadcast receiving apparatus 100 together with a message 310 informing the screen switching.

In the switching time 320, a switching time is displayed continuously by the second when screens are switched. That is, if a user enters a screen switch command by handling a certain key, the controller 190 counts the time from the point of receiving the screen switch command, and displays the time on the screen until just before the screens are switched, the time being displayed as “1 second has passed”, “2 seconds have passed”, . . . , “9 seconds has passed”, “10 seconds have passed”, and so on.

In the latest switching time 330, the switching time taken for the latest screen switching is displayed by the second. That is, if a user inputs a screen switch command, the controller 190 displays the switching time that is written in the buffer 160 most recently as the latest switching time on the screen.

In the average switching time 340, the controller 190 displays the averaged switching time of the switching times stored in the buffer 160 by the second. That is, if a user inputs a screen switch command, the controller 190 averages the switching times stored in the buffer 160 and displays it as the average switching time on the screen.

In the longest switching time 350, the longest switching time from amongst the switching times stored in the buffer 160 is displayed by the second. That is, if a user inputs a screen switch command, the controller 190 displays the longest switching time from amongst the switching times stored in the buffer 160 as the longest switching time on the screen.

FIG. 3B shows an example of a screen switching time display function of the broadcast receiving apparatus according to another embodiment of the invention.

Referring to FIG. 3B, a progress bar 360 representing the processing of a screen switching is displayed on the screen 300 of the broadcast receiving apparatus 100. That is, if a user inputs a screen switch command, the controller 190 counts the time from the point of receiving the screen switch command, and fills in the progress bar 360 displayed in white color with black color. The user can confirm that screen switching is in progress through the change of the progress bar 360.

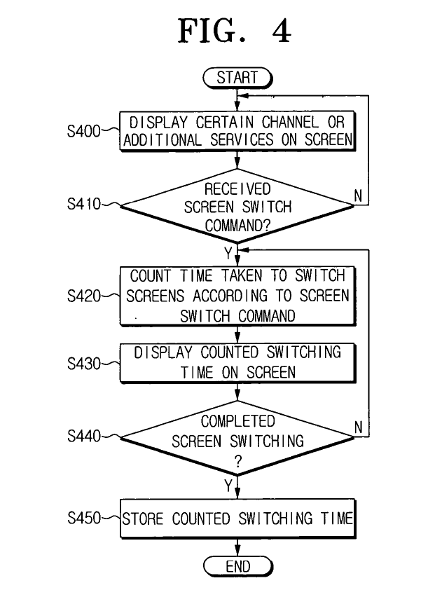

FIG. 4 is a flowchart explaining the operation of the broadcast receiving apparatus according to one embodiment of the invention.

Referring to FIGS. 2 to 4, first, the controller 190 displays the program of a certain channel or the list of additional services on the screen according to a user's handling of a remote controller 200 or keypad. That is, the controller 190 controls the broadcast signal receiver 110, broadcast signal separator 120, signal processor 130, and display 140 so as to receive the broadcast signals corresponding to the channel that is selected according to the external control signal, and display the broadcast signals on the screen S400.

At this point, if a user handles a certain key and enters a screen switch command, the controller 190 receives the screen switch command through the control signal receiver 180 S410.

Then, the controller 190 counts the time required to switch screens according to the screen switch command S420, and controls the UI creator 150 and the display 140 so as to display the time being counted on the screen S430. That is, the controller 190 counts the time from the point of receiving a screen switch command, and displays the latest switching time 330, average switching time 340, and longest switching time 350 on the screen, together with the switching time 320. Otherwise, the switching time can be displayed in the form of a progress bar 360.

At this point, the screen switching time is displayed automatically or manually on the screen according to a preset state determined by the user. That is, if a user sets the screen switching time display function to automatic display through an OSD menu, the controller 190 displays the switching time on the screen upon receiving a screen switch command. If a user selects manual display through an OSD menu, the screen switching time is not displayed, and, when a user handles a certain key, the switching time is displayed on the screen.

If the controller 190 judges that screen switching has been completed S440, the counted switching time is written to the buffer 160 S450. If the controller 190 judges that screen switching has not been completed, the process returns to step S420 in order to continue counting and displaying the switching time.

Through the processes described above, a screen switching time is displayed on a screen while screens are being switched.

As described above, according to the invention, a screen switching time is displayed while screens are being switched, so that the inconvenience that a user feels through the delay of screen switching can be decreased.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A broadcast receiving apparatus comprising:
a control signal receiver configured to receive screen switch commands for switching to a certain screen;
a display that displays a time required to switch screens according to a screen switch command; and
a controller that controls the display so as to count the time required to switch screens according to the screen switch command and display the time on the display, when the screen switch command is received.

2. The apparatus as claimed in claim 1, further comprising:
a buffer that stores at least one switching time, wherein the controller controls the display so as to further display at least any one of the longest switching time, latest switching time taken to switch screens most recently, and average switching time of one or more switching times stored in the buffer, from amongst the switching times stored in the buffer.

3. The apparatus as claimed in claim 1, wherein the controller controls the display so as to display the switching time required to switch screens according to the screen switch command in a form of a progress bar.

4. A method of displaying the screen switching time of a broadcast receiving apparatus, the method comprising:
receiving a screen switch command for switching to a certain screen;
counting a switching time required to switch screens according to the screen switch command; and
displaying the switching time on a screen.

5. The method as claimed in claim 4, wherein, in the displaying the switching time, from amongst the switching times, at least any one of the longest switching time, latest switching time taken to switch screens most recently, and average switching time of one or more stored switching times is further displayed.
